(19) United States
(12) Patent Application Publication
(10) Pub. No.: US 2017/0146863 A1
(43) Pub. Date: May 25, 2017

(54) TRANSPARENT DISPLAY

(71) Applicant: Wuhan China Star Optoelectronics Technology Co., Ltd., Wuhan (CN)

(72) Inventor: Yuejun TANG, Shenzhen (CN)

(73) Assignee: Wuhan China Star Optoelectronics Technology Co., Ltd., Wuhan (CN)

(21) Appl. No.: 15/055,593

(22) Filed: Feb. 27, 2016

(30) Foreign Application Priority Data
Nov. 25, 2015 (CN) 201510836217.0

(51) Int. Cl. G02F 1/1337; G02F 1/1343; G02F 1/1335

(52) U.S. Cl. CPC G02F 1/133753; G02F 1/133528; G02F 1/1337; G02F 1/134309; G02F 2001/133531; G02F 2001/133757

(57) ABSTRACT

The present invention discloses a transparent display, including a lower polarizer, a first substrate, a first alignment film, a liquid crystal layer, a second alignment film, a second substrate and an upper polarizer, which are sequentially stacked up in an image display direction, and the transparent display includes a plurality of transparent regions and a plurality of display regions, which are alternately located, and a polarization axis of the lower polarizer extends along a first direction, and a polarization axis of the upper polarizer extends along a second direction perpendicular with the first direction, and the liquid crystal layer includes a first liquid crystal layer at a surface of the first alignment film, and a second liquid crystal layer at a surface of the second alignment film.

### FIELD OF THE INVENTION

The present invention relates to a transparent display technology field, and more particularly to a transparent display.

### BACKGROUND OF THE INVENTION

The transparent display means that the display itself possesses the light penetration of a certain degree, which can allow the user can clearly see the background behind the display as watching the display image of the display. Therefore, the transparent display is applied for building widows, car windows or shop windows.

The transparent display comprises transparent regions (i.e. capable of transmitting the external light) and display regions (RGB pixel regions). Meanwhile, the common display modes have TN (Twisted Nematic), IPS (In Plane switching), FFS (Fringe Field Switching), multi-domain VA (Vertical alignment). In most usage scenarios, the transparent display is required to be in a transparent state and not to perform display in the most of the time. Only when people need to watch the display image, the transparent display or the opaque display is performed. In the display technologies according to prior art, the IPS mode and the FFS mode have display quality advantages of wide view angle, high contrast than the TN mode. However, the transparent regions of the transparent display performing display in the IPS mode and the FFS mode are in the normally black display mode. Only the voltages are applied to the transparent regions of the aforesaid transparent display, the transparent condition of the transparent regions can be maintained. Therefore, the power consumption of the aforesaid transparent display is large and the application field is restricted.

### SUMMARY OF THE INVENTION

An objective of the present invention is to provide a transparent display to solve the aforesaid issue.

For realizing the aforesaid objective, the technical solution utilized by the embodiments of the present invention is:

provided is a transparent display, comprising a lower polarizer, a first substrate, a first alignment film, a liquid crystal layer, a second alignment film, a second substrate and an upper polarizer, which are sequentially stacked up in an image display direction, and in a direction parallel with the image display plane of the transparent display, the transparent display comprises a plurality of transparent regions and a plurality of display regions, which are alternately located, and a polarization axis of the lower polarizer extends along a first direction, and a polarization axis of the upper polarizer extends along a second direction perpendicular with the first direction, and the liquid crystal layer comprises a first liquid crystal layer at a surface of the first alignment film, and a second liquid crystal layer at a surface of the second alignment film and a plurality of liquid crystals between the first liquid crystal layer and the second liquid crystal layer, and both initial directions of long axes of the first liquid crystal layer and the second liquid crystal layer in the display regions are consistent with the first direction or the second direction, and initial directions of long axes of the first liquid crystal layer and/or the second liquid crystal layer in the transparent regions deviate from the first direction and the second direction.

Preferably, the first alignment film in the display region has a first alignment direction, and the first alignment film in the transparent region has a second alignment direction, and the second alignment film in the display region has a third alignment direction, and the second alignment film in the transparent region has a fourth alignment direction, and the first alignment direction and the third alignment direction are consistent with the first direction or the second direction, and the second alignment direction or/and the fourth alignment direction form an included angle which is larger than or equal to 30° with the first direction or the second direction.

Preferably, the second alignment direction and the first direction form an included angle between 30° to 90°, and the fourth alignment direction is parallel with the first direction; or the second alignment direction and the second direction form an included angle between 30° to 90°, and the fourth alignment direction is parallel with the second direction.

Preferably, the transparent display further comprises a first electrode, and the first electrode is located between the first substrate and the first alignment film, and the first electrode in the transparent region comprises a plurality of first wire electrodes, and an extension direction of the plurality of first wire electrodes is perpendicular with the first direction or the second direction.

Preferably, both the second alignment direction and the fourth alignment direction form an included angle between 35° to 65° with the first direction or the second direction.

Preferably, the transparent display further comprises a first electrode and a second electrode, and the first electrode is located between the first substrate and the first alignment film, and the second electrode is located between the second alignment film and the second substrate, and the first electrode in the transparent region comprises a plurality of first wire electrodes, and the second electrode in the transparent region comprises a plurality of second wire electrodes, and both extension directions of the plurality of first wire electrodes and the plurality of second wire electrodes are perpendicular with the first direction or the second direction.

Preferably, the first electrode further comprises a plurality of third wire electrodes located in the display region, and the third wire electrode appears to be linear and an extension direction forms an included angle between 1° to 25° with the first direction and the second direction.

Preferably, the first electrode further comprises a plurality of third wire electrodes located in the display region, and the third wire electrode appears to be a V shape and extension directions of two sides of the third wire electrode form included angles between 1° to 25° with the first direction and the second direction.

Preferably, the transparent display further comprises a first electrode and a second electrode, and the first electrode is located between the first substrate and the first alignment film, and the second electrode is located between the second alignment film and the second substrate, and the first electrode comprises a first plane electrode covering all liquid crystals of the liquid crystal layer in the transparent regions, and the second electrode comprises a second plane electrode covering all liquid crystals of the liquid crystal layer in the transparent regions.

Preferably, the first electrode further comprises a plurality of third wire electrodes located in the display region and an extension direction of the plurality of third wire electrodes forms an included angle between 1° to 25° with the first direction and the second direction.

Compared with prior art, the present invention possesses benefits below:

In the transparent display of the present invention, as the natural light penetrates the lower polarizer, the lower polarizer transmits the linear polarization light parallel with the first direction, and as the linear polarized light of the first direction enters the liquid crystal layer in the transparent region, the initial directions of long axes of the first liquid crystal layer and/or the second liquid crystal layer in the transparent region 102 deviate from the first direction and the second direction, the linear polarized light of the first direction is converted into the elliptical polarized light or the linear polarized light that the polarization direction is changed under the phase delay function of the liquid crystal. The main vibration direction of the elliptical polarized light or the vibration direction of the linear polarized light deviate 90 deg, and thus it can outgoes from the transparent display through the upper polarizer. Therefore, the transparent regions of the transparent display are the normally white mode. According to the transparent display of the present invention, the transparent display of the transparent regions can be realized under circumstance that the liquid crystal layer is not applied with the voltage to satisfy the requirement of the user for the transparent display to be in the transparent state in a long period of time, and the energy consumption is low. It is beneficial for the diversified applications of the transparent display.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a structure diagram of a transparent display provided by the embodiment of the present invention.

FIG. 2 is an enlarged diagram of a structure at the A position in FIG. 1.

FIG. 3 is an initial position diagram of the liquid crystals and the electrode at the second alignment film in a transparent display provided by the first preferred embodiment of the present invention.

FIG. 4 is an initial position diagram of the liquid crystals and the electrode at the first alignment film in a transparent display provided by the first preferred embodiment of the present invention.

FIG. 5 is an initial position diagram of the liquid crystals and the electrode at the second alignment film in a transparent display provided by the fifth preferred embodiment of the present invention.

FIG. 6 is an initial position diagram of the liquid crystals and the electrode at the first alignment film in a transparent display provided by the fifth preferred embodiment of the present invention.

FIG. 7 is an initial position diagram of the liquid crystals and the electrode at the second alignment film in a transparent display provided by the sixth preferred embodiment of the present invention.

FIG. 8 is an initial position diagram of the liquid crystals and the electrode at the first alignment film in a transparent display provided by the sixth preferred embodiment of the present invention.

FIG. 9 is an initial position diagram of the liquid crystals and the electrode at the second alignment film in a transparent display provided by the eighth preferred embodiment of the present invention.

FIG. 10 is an initial position diagram of the liquid crystals and the electrode at the first alignment film in a transparent display provided by the eighth preferred embodiment of the present invention.

### DETAILED DESCRIPTION OF PREFERRED EMBODIMENTS

For better explaining the technical solution and the effect of the present invention, the present invention will be further described in detail with the accompanying drawings in the specific embodiments.

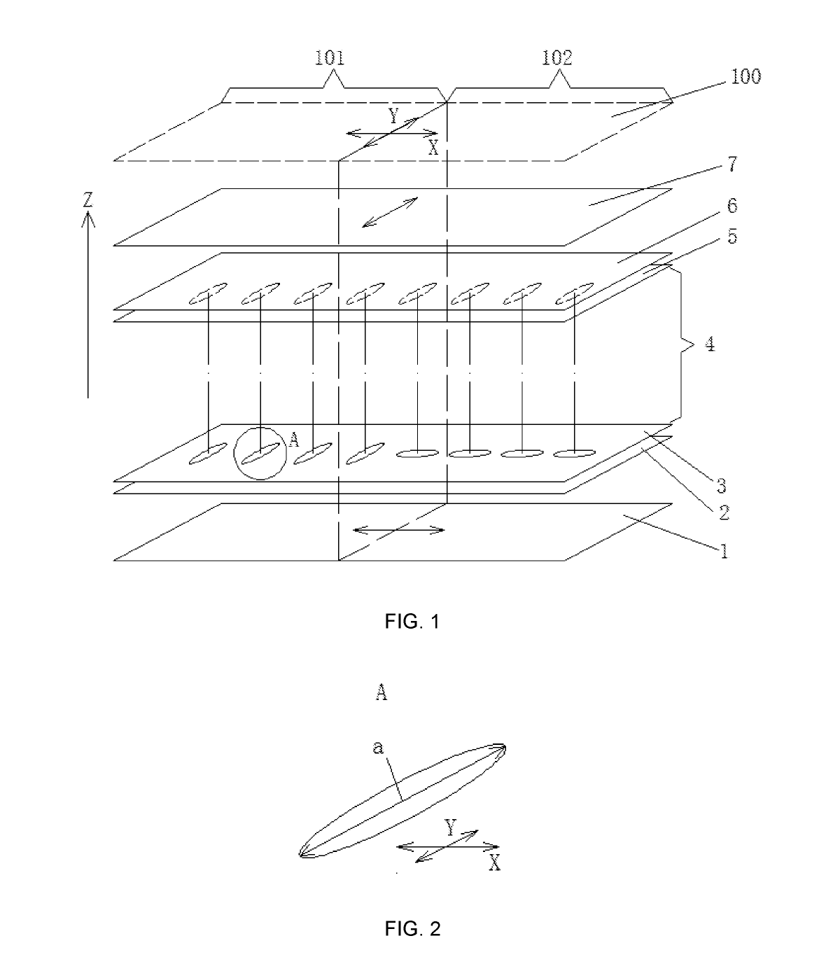

Please refer to FIG. 1 and FIG. 2. FIG. 1 is a structure diagram of a transparent display provided by the embodiment of the present invention. FIG. 2 is an enlarged diagram of a structure at the A position in FIG. 1. The transparent display in this embodiment comprises a lower polarizer 1, a first substrate 2, a first alignment film 3, a liquid crystal layer 4, a second alignment film 5, a second substrate 6 and an upper polarizer 7, which are sequentially stacked up in an image display direction Z (as shown in FIG. 1). In a direction parallel with the image display plane 100 (the dot line plane 100 shown in FIG. 1, and the plane means the plane of showing the image at the most outer layer of the transparent display) of the transparent display, the transparent display comprises a plurality of transparent regions 101 and a plurality of display regions 102, which are alternately located.

It is understood that as shown in FIG. 1, the X direction and the Y direction which are orthogonal with each other are defined. Both the X direction and the Y direction are parallel with the image display plane 100 of the transparent display. In this embodiment, the transparent regions 101 and the display regions 102 can be alternately located along the X direction. Certainly, the transparent regions 101 and the display regions 102 also can be alternately located along the Y direction or other direction parallel with the image display plane 100. Meanwhile, the transparent regions 101 and the display regions 102 can have many kinds of alternate locations. For instance, transparent region 101—display region 102—transparent region 101, transparent region 101—transparent region 101—display region 102—transparent region 101 can be illustrated. The repeated description is omitted here.

In this embodiment, a polarization axis of the lower polarizer 1 extends along a first direction, and a polarization axis of the upper polarizer 7 extends along a second direction perpendicular with the first direction. For convenience for explanation below, the first direction in this embodiment is defined to be consistent with the X direction shown in FIG. 1 (the first direction X in the following), and the second direction is consistent with the Y direction shown in FIG. 1 (the second direction Y in the following). It is understood that the first direction in this embodiment also can be consistent with the Y direction shown in FIG. 1, and the second direction is consistent with the X direction shown in FIG. 1. Or, the first direction and the second direction also can be other directions. The repeated description is omitted hereafter. Certainly, the first direction X and the second direction Y are not restricted to be the pointing directions shown in FIG. 1 but other directions. FIG. 1 merely shows that the first direction X and the second direction Y are orthogonal with each other. As shown in FIG. 1, the liquid crystal layer 4 comprises a first liquid crystal layer at a surface of the first alignment film 3, and a second liquid crystal layer at a surface of the second alignment film 5 and a plurality of liquid crystals between the first liquid crystal layer and the second liquid crystal layer. Specifically, the “layer” of the first liquid crystal layer and the second liquid crystal layer should be considered to be the surface layer. Namely, the first liquid crystal layer is a surface layer of liquid crystal contacting with the surface of the first alignment film 3, and the second liquid crystal layer is a surface layer of liquid crystal contacting with the surface of the second alignment film 5. Meanwhile, the “layer” is not restricted to be the alignment of the liquid crystals of the liquid crystal layer 4.

Both initial directions of long axes of the first liquid crystal layer and the second liquid crystal layer in the display regions 101 are consistent with the first direction or the second direction, and initial directions of long axes of the first liquid crystal layer and/or the second liquid crystal layer in the transparent regions deviate from the first direction and the second direction. Namely, the initial directions of long axes of the first liquid crystal layer and/or the second liquid crystal layer are not consistent with the initial directions of long axes of the first liquid crystal layer and the second liquid crystal layer in the display regions 101. As shown in FIG. 2, the axis in figure is the liquid crystal long axis. The initial direction of the long axis means the direction that the liquid crystal in the liquid crystal layer initially points at when the liquid crystal layer is not applied with the voltage.

In the transparent display of the this embodiment, as the natural light penetrates the lower polarizer 1, the lower polarizer 1 transmits the linear polarization light parallel with the first direction, and as the linear polarized light of the first direction enters the liquid crystal layer 4 in the transparent region 102, the initial directions of long axes of the first liquid crystal layer and/or the second liquid crystal layer in the transparent region 102 deviate from the first direction and the second direction, the linear polarized light of the first direction is converted into the elliptical polarized light or the linear polarized light that the polarization direction is changed under the phase delay function of the liquid crystal. The main vibration direction of the elliptical polarized light or the vibration direction of the linear polarized light deviate 90 deg, and thus it can outgoes from the transparent display through the upper polarizer 7. Therefore, the transparent regions 102 of the transparent display are the normally white mode. According to the transparent display of this embodiment, the transparent display of the transparent regions can be realized under circumstance that the liquid crystal layer is not applied with the voltage to satisfy the requirement of the user for the transparent display to be in the transparent state in a long period of time, and the energy consumption is low. It is beneficial for the diversified applications of the transparent display.

Then, the liner polarized light of the first direction entering the display region 101 does not have any changes in the liquid crystal layer 4. Thus, the light is absorbed by the upper polarizer 7. The display region 101 of the transparent display appears a black state.

Furthermore, the first alignment film 3 of the transparent display in the display region 101 has a first alignment direction, and the first alignment film 3 in the transparent region 102 has a second alignment direction. The second alignment film in the display region 101 has a third alignment direction, and the second alignment film in the transparent region 102 has a fourth alignment direction. the first alignment direction and the third alignment direction are consistent with the first direction or the second direction, and the second alignment direction or/and the fourth alignment direction form an included angle which is larger than or equal to 30° with the first direction or the second direction. Preferably, the second alignment direction and the first direction form an included angle between 30° to 90°, and the fourth alignment direction is parallel with the first direction; or the second alignment direction and the second direction form an included angle between 30° to 90°, and the fourth alignment direction is parallel with the second direction; or the fourth alignment direction and the first direction form an included angle between 30° to 90°, and the second alignment direction is parallel with the first direction; or the fourth alignment direction and the second direction form an included angle between 30° to 90°, and the second alignment direction is parallel with the second direction; or both the second alignment direction and the fourth alignment direction form an included angle between 35° to 65° with the first direction or the second direction.

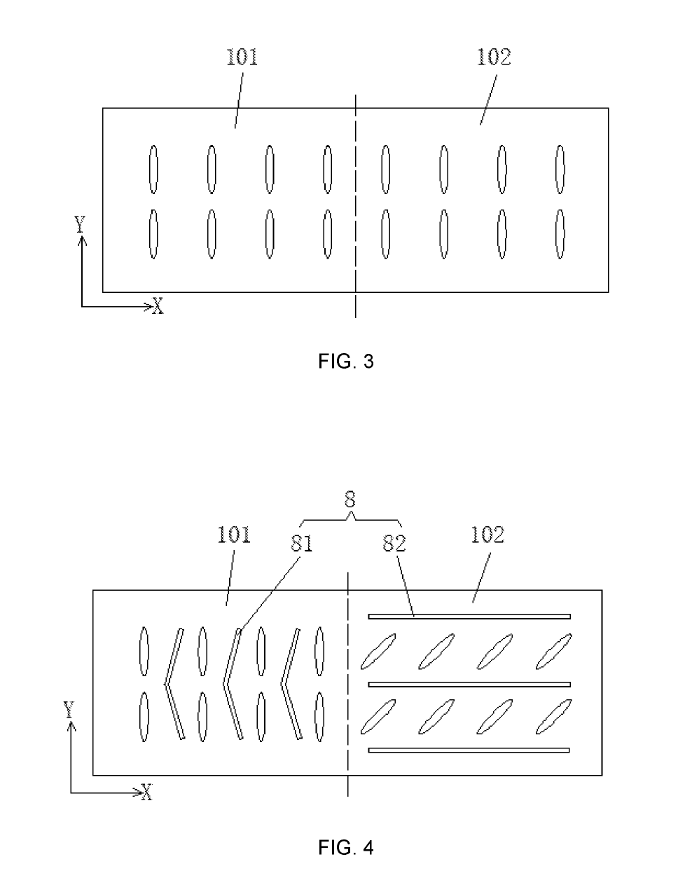

The preferred embodiment of the present invention provides a transparent display. Please refer to FIG. 1, FIG. 3 and FIG. 4. The display comprises a lower polarizer 1, a first substrate 2, a first alignment film 3, a liquid crystal layer 4, a second alignment film 5, a second substrate 6 and an upper polarizer 7, which are sequentially stacked up in an image display direction Z. A polarization axis of the lower polarizer 1 extends along a first direction X, and a polarization axis of the upper polarizer 7 extends along a second direction Y perpendicular with the first direction. The first alignment film 3 of the transparent display in the display region 101 has a first alignment direction, and the first alignment film 3 in the transparent region 102 has a second alignment direction. The second alignment film 5 in the display region 101 has a third alignment direction, and the second alignment film 5 in the transparent region 102 has a fourth alignment direction. All the first alignment direction, the third alignment direction and the fourth alignment direction are consistent with the second direction Y, and the second alignment direction and the second direction Y form an included angle between 30° to 90°. The transparent display in this embodiment further comprises a first electrode 8, and the first electrode 8 is located between the first substrate 2 and the first alignment film 3, and the first electrode 8 in the transparent region 102 comprises a plurality of first wire electrodes 82, and an extension direction of the plurality of first wire electrodes 82 is perpendicular with the second direction Y.

It can be understood that as the liquid crystal layer 4 of the transparent display in this embodiment is applied with enough voltage, the liquid crystal located in the transparent region 102 will have direction change. Ultimately, the long axis of the liquid crystal will be consistent with the second direction Y. The liner polarized light of the first direction penetrating the lower polarizer 1 does not have phase delay in the liquid crystal layer 4 of the transparent region 102 and cannot outgo through the upper polarizer 7, and the transparent region appears the dark state. In the transparent display of this embodiment, under circumstance that the liquid crystal layer is applied with the enough voltage, the transparent region appear the dark state, and thus will not interfere with display image of the display region to ensure the high quality display of the transparent display. Furthermore, the liquid crystal twist condition can be controlled by controlling the voltage applied to the liquid crystal layer in the transparent region 102 to control the transparency of the transparent region 102 for satisfying the diversified display modes.

Furthermore, the first electrode 8 further comprises a plurality of third wire electrodes 81 located in the display region 101 and an extension direction of the plurality of third wire electrodes 81 forms an included angle between 1° to 25° with the second direction Y. Preferably, the third wire electrode 81 appears to be linear and an extension direction forms an included angle between 1° to 25° with the second direction Y; or, the third wire electrode 81 appears to be a V shape and extension directions of two sides thereof form included angles between 1° to 25° with the second direction Y.

It should be understood that as the transparent display employs the IPS (In Plane switching) display mode for performing display, the first electrode 8 comprises a pixel electrode and a common electrode; as the transparent display employs the FFS (Fringe Field Switching) display mode for performing display, the first electrode 8 is a Top ITO, and then the transparent display further comprises a third electrode (not shown) between the first electrode 8 and the first substrate 2, and the third electrode is a Bottom ITO, and the first electrode 8 is the pixel electrode (or the common electrode), and the third electrode is the common electrode (or the pixel electrode).

The second preferred embodiment of the present invention provides a transparent display. The difference from the transparent display of the first preferred embodiment is: all the first alignment direction, the third alignment direction and the fourth alignment direction are consistent with the first direction X, and the second alignment direction and the first direction X form an included angle between 30° to 90°. An extension direction of the plurality of first wire electrodes 82 is perpendicular with the first direction X, and an extension direction of the plurality of third wire electrodes 81 forms an included angle between 1° to 25° with the first direction X. The working principle of the transparent display in this preferred embodiment is similar with the first preferred embodiment. The repeated description is omitted here.

The third preferred embodiment of the present invention provides a transparent display. The difference from the transparent display of the first preferred embodiment is: all the first alignment direction, the third alignment direction and the second alignment direction are consistent with the second direction Y, and the fourth alignment direction and the second direction Y form an included angle between 30° to 90°. The transparent display in this embodiment further comprises a first electrode 8, and the first electrode 8 is located between the second substrate 6 and the second alignment film 5, and the first electrode 8 comprises a plurality of first wire electrodes 82 located in the transparent region 102 and a plurality of third wire electrodes 81 located in the display region 101, and an extension direction of the plurality of first wire electrodes 82 is perpendicular with the second direction Y, and an extension direction of the plurality of third wire electrodes 81 forms an included angle between 1° to 25° with the second direction Y. The working principle of the transparent display in this preferred embodiment is similar with the first preferred embodiment. The repeated description is omitted here.

The second preferred embodiment of the present invention provides a transparent display. The difference from the transparent display of the third preferred embodiment is: all the first alignment direction, the third alignment direction and the second alignment direction are consistent with the first direction X, and the fourth alignment direction and the first direction X form an included angle between 30° to 90°. An extension direction of the plurality of first wire electrodes 82 is perpendicular with the first direction X, and an extension direction of the plurality of third wire electrodes 81 forms an included angle between 1° to 25° with the first direction X. The working principle of the transparent display in this preferred embodiment is similar with the first preferred embodiment. The repeated description is omitted here.

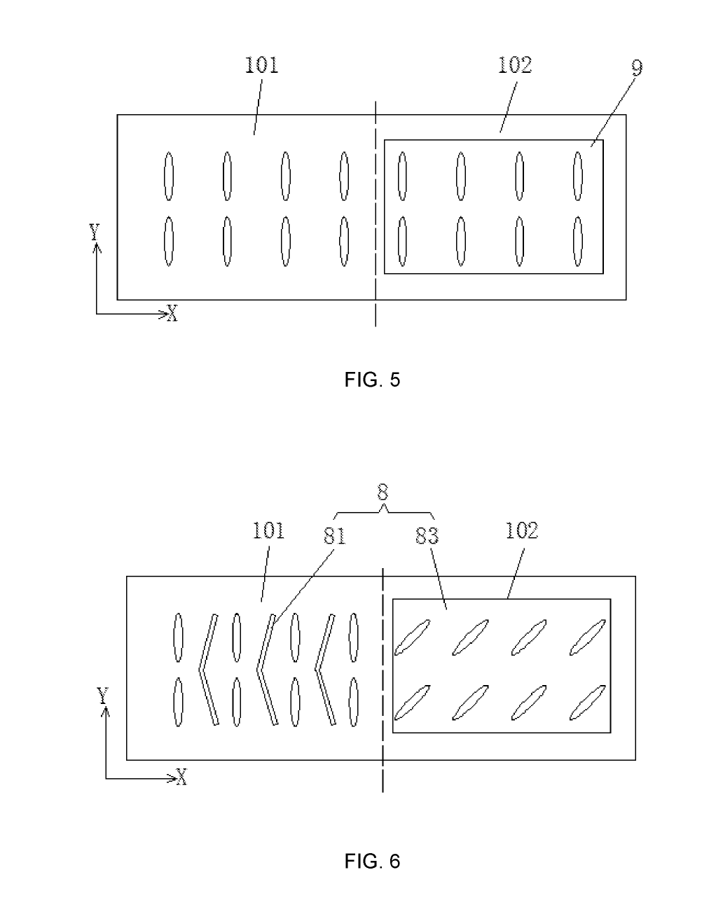

The fifth preferred embodiment of the present invention provides a transparent display. Please refer to FIG. 1, FIG. 5 and FIG. 6. The difference from the aforesaid embodiment is: the transparent display comprises a first electrode 8 and a second electrode 9, and the first electrode 8 is located between the first substrate 2 and the first alignment film 3, and the second electrode 9 is located between the second alignment film 5 and the second substrate 6. The first electrode 8 comprises a first plane electrode 83 covering all liquid crystals of the liquid crystal layer in the transparent regions 101, and the second electrode 9 comprises a second plane electrode covering all liquid crystals of the liquid crystal layer in the transparent regions.

It can be understood that as the liquid crystal layer 4 of the transparent display in this embodiment is applied with enough voltage, the liquid crystal located in the transparent region 102 will have direction change. Ultimately, the long axis of the liquid crystal will be consistent with the image display direction Z. The liner polarized light of the first direction penetrating the lower polarizer 1 does not have phase delay in the liquid crystal layer 4 of the transparent region 102 and cannot outgo through the upper polarizer 7, and the transparent region appears the dark state. In the transparent display of this embodiment, under circumstance that the liquid crystal layer is applied with the enough voltage, the transparent region appear the dark state, and thus will not interfere with display image of the display region to ensure the high quality display of the transparent display. Furthermore, the liquid crystal twist condition can be controlled by controlling the voltage applied to the liquid crystal layer in the transparent region 102 to control the transparency of the transparent region 102 for satisfying the diversified display modes.

It should be understood that in this embodiment, the arrangement of the electrodes corresponding to the liquid crystal of the display region 101 can be referred to the aforesaid preferred embodiment for implementing flexible design.

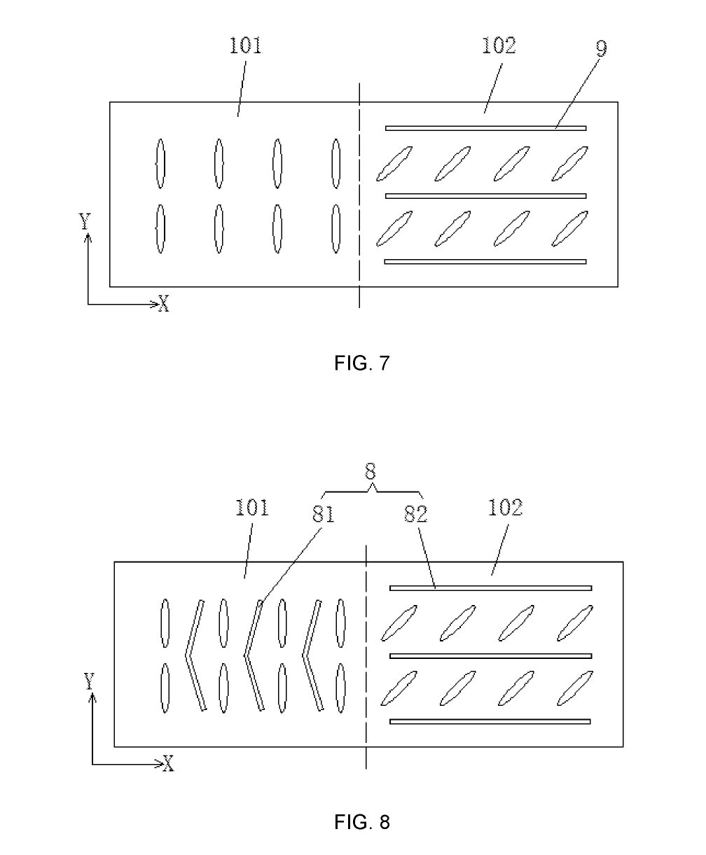

The sixth preferred embodiment of the present invention provides a transparent display. Please refer to FIG. 1, FIG. 7 and FIG. 8. The difference between the transparent displays of this preferred embodiment and the aforesaid preferred embodiment is: the first alignment direction and the third alignment direction are consistent with the second direction Y, and both the second alignment direction and the fourth alignment direction form an included angle between 35° to 65° with the second direction Y; the transparent display of this embodiment further comprises a first electrode 8 and a second electrode 9, and the first electrode 8 is located between the first substrate 2 and the first alignment film 3, and the second electrode 9 is located between the second alignment film 5 and the second substrate 6. The first electrode 8 in the transparent region 102 comprises a plurality of first wire electrodes 82, and an extension direction of the plurality of first wire electrodes 82 is perpendicular with the second direction Y. The second electrode 9 in the transparent region 102 comprises a plurality of second wire electrodes, and an extension direction of the plurality of second wire electrodes is perpendicular with the second direction Y.

It can be understood that as the liquid crystal layer 4 of the transparent display in this embodiment is applied with enough voltage, the liquid crystal located in the transparent region 102 will have direction change. Ultimately, the long axis of the liquid crystal will be consistent with the second direction Y. The liner polarized light of the first direction penetrating the lower polarizer 1 does not have phase delay in the liquid crystal layer 4 of the transparent region 102 and cannot outgo through the upper polarizer 7, and the transparent region appears the dark state. In the transparent display of this embodiment, under circumstance that the liquid crystal layer is applied with the enough voltage, the transparent region appear the dark state, and thus will not interfere with display image of the display region to ensure the high quality display of the transparent display. Furthermore, the liquid crystal twist condition can be controlled by controlling the voltage applied to the liquid crystal layer in the transparent region 102 to control the transparency of the transparent region 102 for satisfying the diversified display modes.

It should be understood that in this embodiment, the arrangement of the electrodes corresponding to the liquid crystal of the display region 101 can be referred to the aforesaid preferred embodiment for implementing flexible design.

The seventh preferred embodiment of the present invention provides a transparent display. The difference from the transparent display of the sixth preferred embodiment is: the first alignment direction and the third alignment direction are consistent with the first direction X, and both the second alignment direction and the fourth alignment direction form an included angle between 35° to 65° with the first direction X; an extension direction of the plurality of first wire electrodes 82 is perpendicular with the first direction X, and an extension direction of the plurality of second wire electrodes is perpendicular with the first direction X. The working principle of the transparent display in this preferred embodiment is similar with the sixth preferred embodiment. The repeated description is omitted here.

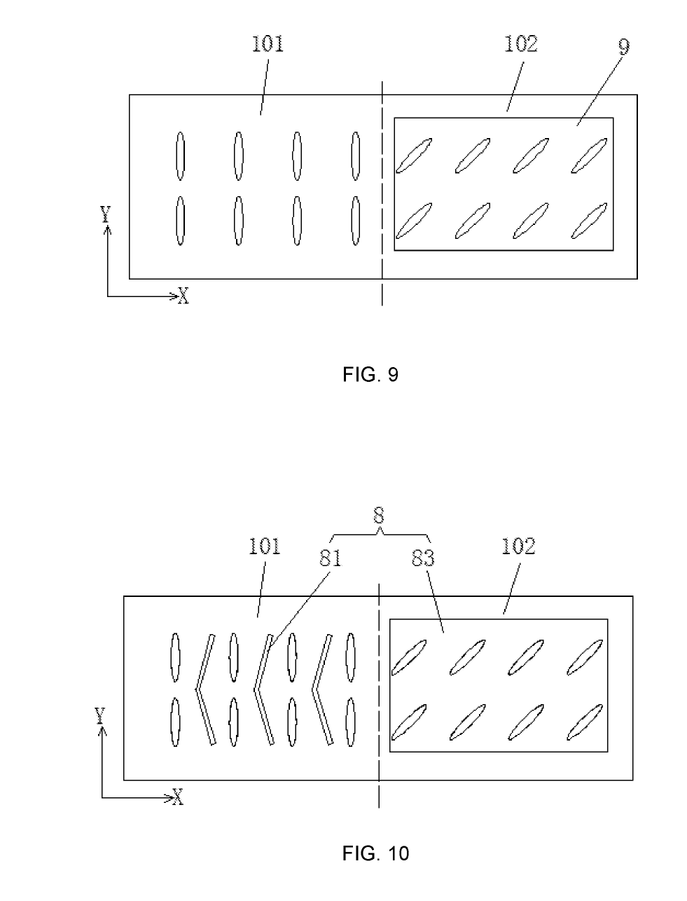

The eighth preferred embodiment of the present invention provides a transparent display. Please refer to FIG. 1, FIG. 9 and FIG. 10. The difference from the transparent displays of the sixth preferred embodiment and the seventh preferred embodiment is: the first electrode 8 comprises a first plane electrode 83 covering all liquid crystals of the liquid crystal layer in the transparent regions, and the second electrode 9 comprises a second plane electrode covering all liquid crystals of the liquid crystal layer in the transparent regions.

It can be understood that as the liquid crystal layer 4 of the transparent display in this embodiment is applied with enough voltage, the liquid crystal located in the transparent region 102 will have direction change. Ultimately, the long axis of the liquid crystal will be consistent with the image display direction Z. The liner polarized light of the first direction penetrating the lower polarizer 1 does not have phase delay in the liquid crystal layer 4 of the transparent region 102 and cannot outgo through the upper polarizer 7, and the transparent region appears the dark state. In the transparent display of this embodiment, under circumstance that the liquid crystal layer is applied with the enough voltage, the transparent region appear the dark state, and thus will not interfere with display image of the display region to ensure the high quality display of the transparent display. Furthermore, the liquid crystal twist condition can be controlled by controlling the voltage applied to the liquid crystal layer in the transparent region 102 to control the transparency of the transparent region 102 for satisfying the diversified display modes.

It should be understood that in this embodiment, the arrangement of the electrodes corresponding to the liquid crystal of the display region 101 can be referred to the aforesaid preferred embodiment for implementing flexible design.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A transparent display, comprising a lower polarizer, a first substrate, a first alignment film, a liquid crystal layer, a second alignment film, a second substrate and an upper polarizer, which are sequentially stacked up in an image display direction, and
in a direction parallel with the image display plane of the transparent display, the transparent display comprises a plurality of transparent regions and a plurality of display regions, which are alternately located, and
a polarization axis of the lower polarizer extends along a first direction, and a polarization axis of the upper polarizer extends along a second direction perpendicular with the first direction, and
the liquid crystal layer comprises a first liquid crystal layer at a surface of the first alignment film, and a second liquid crystal layer at a surface of the second alignment film and a plurality of liquid crystals between the first liquid crystal layer and the second liquid crystal layer, and
both initial directions of long axes of the first liquid crystal layer and the second liquid crystal layer in the display regions are consistent with the first direction or the second direction, and initial directions of long axes of the first liquid crystal layer and/or the second liquid crystal layer in the transparent regions deviate from the first direction and the second direction.

2. The transparent display according to claim 1, wherein the first alignment film in the display region has a first alignment direction, and the first alignment film in the transparent region has a second alignment direction, and
the second alignment film in the display region has a third alignment direction, and the second alignment film in the transparent region has a fourth alignment direction, and
the first alignment direction and the third alignment direction are consistent with the first direction or the second direction, and the second alignment direction or/and the fourth alignment direction form an included angle which is larger than or equal to 30° with the first direction or the second direction.

3. The transparent display according to claim 2, wherein the second alignment direction and the first direction form an included angle between 30° to 90°, and the fourth alignment direction is parallel with the first direction;
or the second alignment direction and the second direction form an included angle between 30° to 90°, and the fourth alignment direction is parallel with the second direction.

4. The transparent display according to claim 3, wherein the transparent display further comprises a first electrode, and the first electrode is located between the first substrate and the first alignment film, and the first electrode in the transparent region comprises a plurality of first wire electrodes, and an extension direction of the plurality of first wire electrodes is perpendicular with the first direction or the second direction.

5. The transparent display according to claim 2, wherein both the second alignment direction and the fourth alignment direction form an included angle between 35° to 65° with the first direction or the second direction.

6. The transparent display according to claim 5, wherein the transparent display further comprises a first electrode and a second electrode, and the first electrode is located between the first substrate and the first alignment film, and the second electrode is located between the second alignment film and the second substrate, and the first electrode in the transparent region comprises a plurality of first wire electrodes, and the second electrode in the transparent region comprises a plurality of second wire electrodes, and both extension directions of the plurality of first wire electrodes and the plurality of second wire electrodes are perpendicular with the first direction or the second direction.

7. The transparent display according to claim 4, wherein the first electrode further comprises a plurality of third wire electrodes located in the display region, and the third wire electrode appears to be linear and an extension direction forms an included angle between 1° to 25° with the first direction and the second direction.

8. The transparent display according to claim 4, wherein the first electrode further comprises a plurality of third wire electrodes located in the display region, and the third wire electrode appears to be a V shape and extension directions of two sides of the third wire electrode form included angles between 1° to 25° with the first direction and the second direction.

9. The transparent display according to claim 3, wherein the transparent display further comprises a first electrode and a second electrode, and the first electrode is located between the first substrate and the first alignment film, and the second electrode is located between the second alignment film and the second substrate, and the first electrode comprises a first plane electrode covering all liquid crystals of the liquid crystal layer in the transparent regions, and the second electrode comprises a second plane electrode covering all liquid crystals of the liquid crystal layer in the transparent regions.

10. The transparent display according to claim 9, wherein the first electrode further comprises a plurality of third wire electrodes located in the display region and an extension direction of the plurality of third wire electrodes forms an included angle between 1° to 25° with the first direction and the second direction.
